(19) United States
(12) Patent Application Publication
(10) Pub. No.: US 2002/0138448 A1
(43) Pub. Date: Sep. 26, 2002

(54) Method and apparatus for a virtual e-box

(76) Inventor: Mehmed K. Younouzov, Kansas City, MO (US)

Correspondence Address: CHASE & YAKIMO, L.C., 4400 COLLEGE BOULEVARD, SUITE 130, OVERLAND PARK, KS, 66211

(21) Appl. No.: 09/767,169

(22) Filed: Jan. 22, 2001

(51) Int. Cl. G06F 17/60

(52) U.S. Cl. 705/74; 705/26; 713/153

(57) ABSTRACT

A method of protecting the identity and physical address of a user in an online environment is provided which establishes a virtual e-box for the user including a virtual name and address for use by the user when requesting information or purchasing goods over the Internet. Anonymity may be further enhanced by providing the user with a virtual credit card, which is tied to a user's real credit card or other source of payment. Additionally, the user may receive prepaid shipping labels, which include a barcode or other encoded means of accessing a user's web site account to charge to the user the cost of shipping a package affixed with the label.

### BACKGROUND OF THE INVENTION

This invention relates to a method and apparatus for protecting the privacy of online shoppers and other Internet users and, in particular, to a method and apparatus for providing virtual electronic or privacy boxes (e-box) which may be used in an Internet environment to allow an online user to make purchases and receive mail anonymously.

As use of the World Wide Web and Internet has increased, concern about personal data privacy has also increased. In conjunction, personal data collection by Internet service providers, and online vendors and other web sites has expanded. One problem is that an Internet user knowingly or unknowingly provides information over the Internet for one purpose and then that information is used for another purpose. Concerns for privacy and security are some of the reasons people do not shop online.

The Internet is a global network connecting millions of computers. Access to the Internet is provided by Internet service providers (ISP), also called Internet access providers (IAP). One popular part to the Internet is the World Wide Web which consists of a collection of interlinked electronic documents hosted on web site servers that work together using a specific Internet protocol called hypertext transfer protocol (HTTP). HTTP defines how messages are formatted and transmitted and what actions web servers and web browsers installed on user computers should take in response to various commands. These documents are created using a software language called hypertext markup language (HTML), which defines the structure and layout of a web document.

HTML documents are generally static electronic documents. In order to manage user input, HTML documents may include links to executable programs such as Java applets, or control codes such as JavaScript may be integrated into the HTML document using special tags. Java is a programming language similar to C++ that is used to create stand alone executable application programs called applets. JavaScript is a scripting language that is interpreted by the web browser software running on the user's computer.

A user may access the Internet using a personal computer equipped with a modem. Interface software is installed in the personal computer so that when the user wishes to access the Internet, the modem is automatically instructed to dial the telephone number associated with the user's ISP. The user can then browse the Internet to access online information using commercially available browser software such as Netscape Navigator or Microsoft Internet Explorer. This online information is typically organized by web sites and web pages within a web site. Every web page is identified using a unique electronic address or uniform resource locator (URL). Generally, a web page is an electronic document, written in HTML, JavaScript and/or Java, which organizes the presentation of text, graphical images, audio, video, and links to other web pages into a desired display. An interactive web page manages user input in response to events such as a mouse click or keyboard entry to a web page from the user's personal computer. Web sites are accessed through a wide variety of commercial ISPs such as America Online, CompuServe or Microsoft Network.

Commercial sites on the Internet (in particular on the World Wide Web) are known. Typically, web sites where merchandisers' services may be purchased consist of a static description of the good or services being offered, the price at which such goods or services are being offered, and some type of order form for a customer to enter personal payment information. Similarly, online service systems, which allow users to receive information and purchase goods from a variety of different information providers and merchants over a distributed computer network such as the Internet, are also known.

In an online commerce environment, a user can visit a merchant's electronic store or web site and interactively view merchandise or descriptions of services on the user's personal computer. A user may purchase goods or services from these electronic stores by selecting the desired good or service, providing a physical shipping or mailing address, and billing information to the online merchant. This type of system is similar to a mail-order catalog system, where the customer chooses the merchandise, fills out an order form, and mails it to the company for processing.

One significant conflict concerning Internet privacy is what is more important to the user, personalization and convenient use of the Internet, or personal privacy? It has not always been possible to have it both ways. Generally, a user does not have any way of knowing what personal information a web site has collected regarding the user. By giving a web site a minimal amount of information, this information can be used to research other databases on the Internet to develop a more complete profile of the user, completely unknown to the user.

Some companies, consortiums of companies and independent Internet groups have taken the initiative to ensure user privacy by promulgating voluntary guidelines for personal information use. However, to shop online, it has been necessary to disclose certain basic information which identifies the user, the user's physical address, and related information so that the products may be delivered to the user.

### SUMMARY OF THE INVENTION

It is, therefore, a primary object of the present invention to provide a method and apparatus which uses a distributed network, such as the Internet, for creating and recording a virtual name and address for a user to use to order goods anonymously.

Another important object of the present invention is to provide a method and apparatus as aforesaid, which allows a user to receive email anonymously.

Still another important object of the present invention is to provide a method and apparatus as aforesaid, which allows a user to receive prepaid postage labels which may be used to ship letters and packages anonymously.

Yet another important object of the present invention is to provide a method and apparatus as aforesaid, which is integrated with mail and package handler systems to automatically ship a package or letter to the correct physical address based on the virtual name and address.

These and other objects of the present invention are provided by creating and recording a virtual name, virtual privacy box and virtual address (collectively referred to as an e-box) which is selected by a user and is associated with the user's actual name and physical mailing address. This e-box may then be used to order goods over the Internet anonymously. Shippers associated with the e-box service may access the e-box web site to lookup the actual address and optionally, the actual name of the user, to deliver the goods to the user's physical address.

Alternatively, the shipper may deliver the goods to an e-box relabeler, which has access to the e-box web site. The relabeler may then lookup the user's physical address and relabel the package for final delivery to the user by any shipper.

The user may also purchase e-box labels with prepaid postage for applying directly to a package to be shipped. Upon receiving a package with a prepaid e-box label, the shipper or Post Office may access the e-box web site to debit the user's account.

Other objects and advantages of this invention will become apparent from the following description taken in connection with the accompanying drawings, wherein is set forth by way of illustration and example, a now preferred embodiment of this invention.

### BRIEF DESCRIPTION OF THE DRAWINGS

FIG. 1 is a block diagram illustrating a product distribution network according to one preferred embodiment of the invention.

FIG. 2 is a diagrammatic illustration of the layout of a login web page according to one preferred embodiment of the invention.

FIG. 3 is a diagrammatic illustration of the layout of an account set-up web page according to one preferred embodiment of the invention.

FIG. 4 is a diagrammatic illustration of the layout of an account information and prepaid postage web page according to one preferred embodiment of the invention.

### DESCRIPTION OF THE PREFERRED EMBODIMENT

The virtual privacy box (e-box) or privacy box (P-Box) is a method and apparatus for protecting the privacy of online shoppers and other Internet users. The e-box provides an interactive computer implemented system, such as a web site on the World Wide Web, where a user may create an alternative name or alias and address which may be used to make purchases and receive mail anonymously. Additionally, the user may purchase prepaid postage mailing labels from the system.

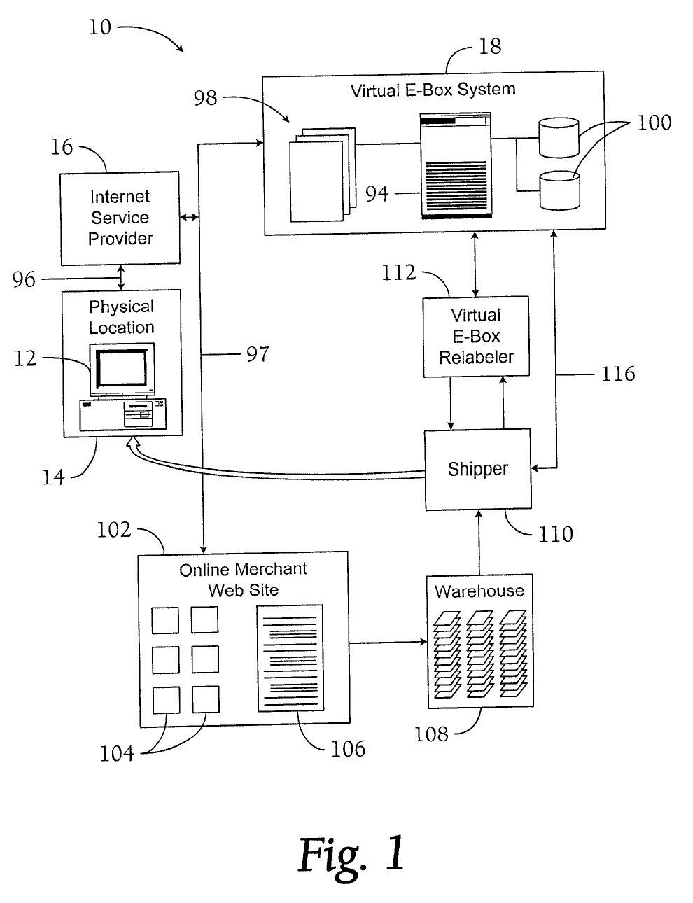

Turning more particularly to the drawings, FIG. 1 illustrates a computer network 10 for connecting client computers 12 at a physical location 14, such as a house or apartment, to web site servers. Access to the Internet 10 is provided by Internet service provider (ISP) 16. Interlinked electronic documents stored on web site servers may be accessed by a user of computer 12 using an Internet protocol called hypertext transfer protocol (HTTP). HTTP defines how messages are formatted and transmitted and what actions the web servers and web browser software loaded on computers 12 should take in response to various commands. These electronic documents stored on a web site server may be created using high-level software languages such as HTML, Java, and JavaScript, which define the structure, layout, and response to the user input of a web document.

A user may access the Internet using personal computer 12 equipped with a modem or other access device. Conventional interface software is installed in personal computer 12 so that when the user wishes to access the Internet, the modem is automatically instructed to dial the telephone number associated with ISP 16. The user can then browse the Internet to access online information stored on computers connected to the Internet.

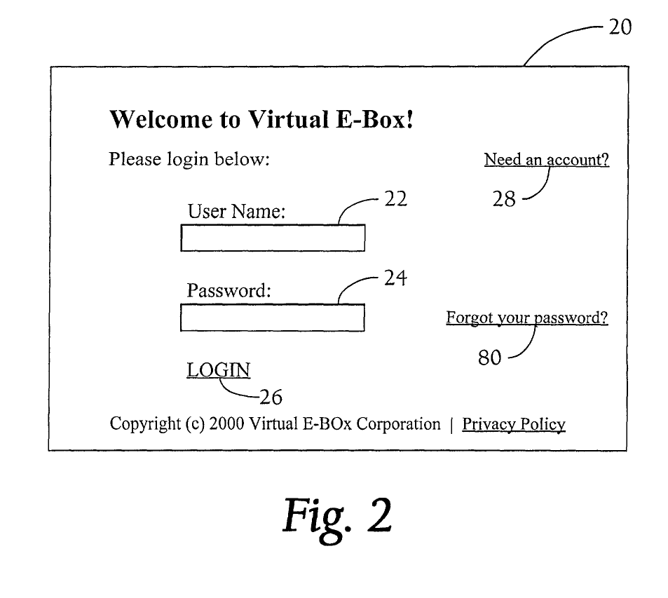

Online information is typically organized by web sites and web pages within a web site. The first page accessed on a web site is typically referred to as the home page, or login page 20 (see FIG. 2). Login page 20 provides access or links to other related web pages within the web site. Every web page is identified using a unique electronic address or uniform resource locator (URL).

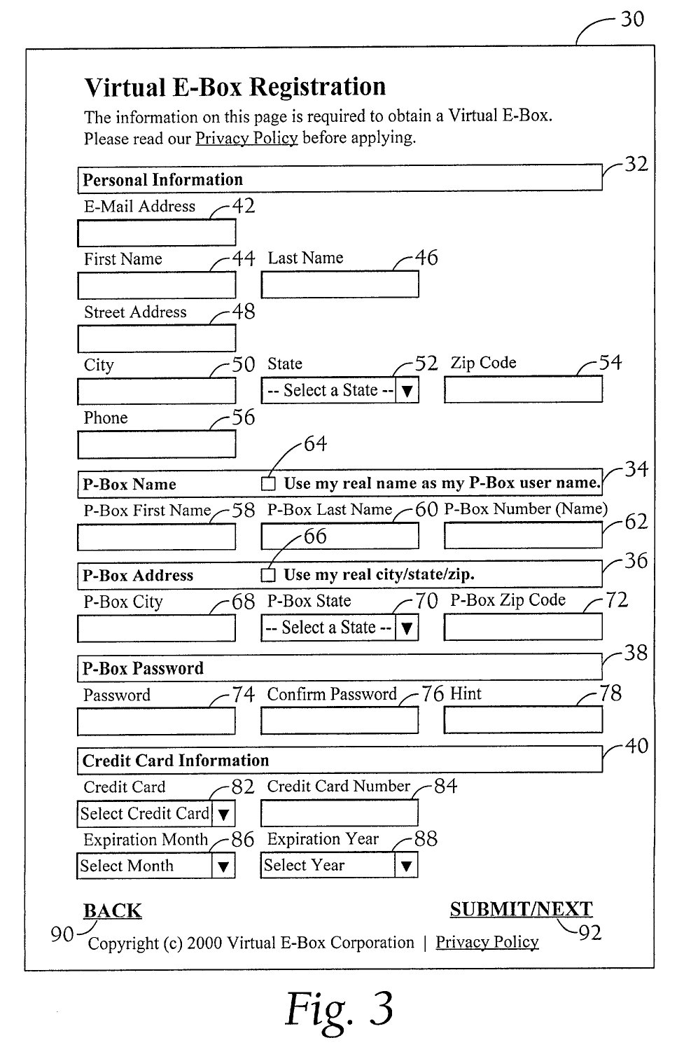

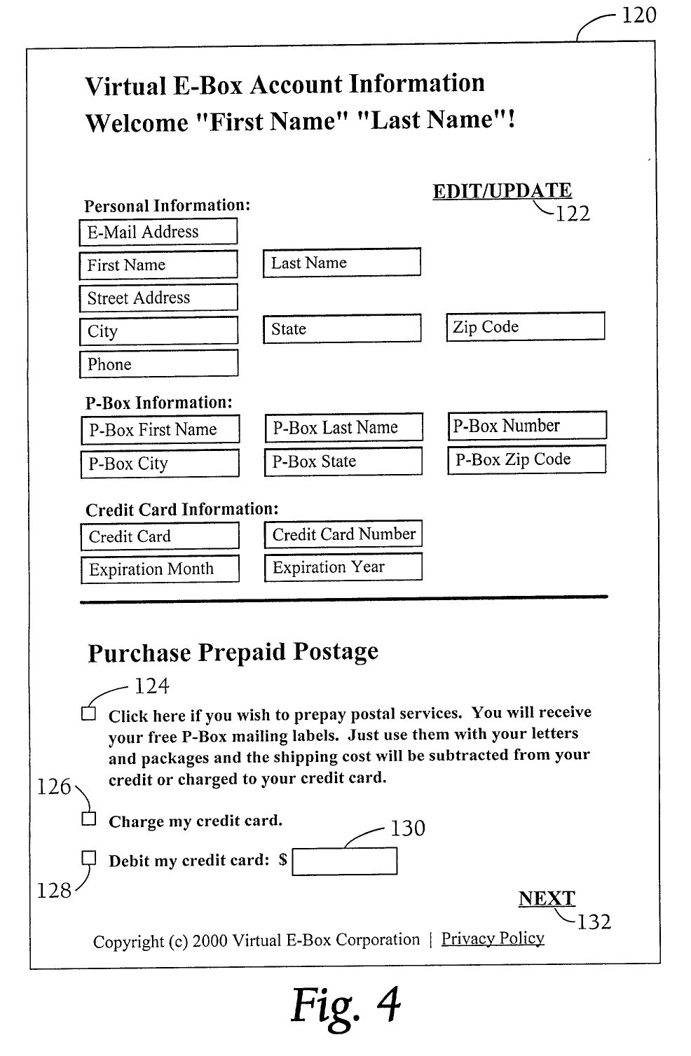

The web site of the preferred embodiment includes login page 20 which is linked to registration page 30 (FIG. 3), a privacy policy page (not shown), an account information page 120 (FIG. 4), and a confirmation page (not shown). The web pages shown in FIGS. 2-4 are for illustrative purposes only, and it should be understood that other pages or links between pages may be implemented.

In the preferred embodiment, a person utilizing personal computer 12 may search the Internet for information relating to privacy mail boxes, personal privacy, virtual e-boxes, or related information using the searching capabilities of the browser software to find a link to login page 20.

If the user knows the URL of a login screen 20, he or she may go directly to this web site by entering the web site address or URL.

Referring to FIGS. 1 and 2, a login screen is illustrated which may be implemented as a web site 18 accessible on the World Wide Web. The World Wide Web is one popular part of the Internet which displays graphical and textual information. Computers which provide information on the World Wide Web are typically called “web sites.” A web site is defined by an Internet address which has an associated electronic page, often called a “home page.” Generally, a web page is an electronic document which organizes the presentation of text, graphically images, audio and video into a desired display. These web sites are operated by a wide variety of entities which are typically called content providers.

A user may access the Internet using a personal computer equipped with a conventional modem. Special interface software is installed in the personal computer so that when the user wishes to access the Internet, the modem is automatically instructed to dial the telephone number associated with the Internet host server. The user can then access information at any address accessible over the Internet.

Information exchanged over the World Wide Web is typically encoded in hypertext markup language (HTML) format. The HTML is a scripting language which is used to generate the web pages for different content providers. In this setting, a content provider is an individual or company that places information or content on the World Wide Web so that it may be accessed by others. As is well know in the art, the HTML format is a set of conventions for displaying an electronic document and for marking different portions of an electronic document so that each portion refers to an embedded function or tag and appears in a distinctive format. For example, the HTML format identifies or tags portions of a document to identify different categories of text. When a web browser, such as Netscape Navigator or Microsoft Internet Explorer, accesses an HTML document, the web browser interprets the imbedded tags in the document so that the text appears formatted in the specified manner.

An HTML document can also include a hypertext reference (HREF) links which allow a user to move from one document to another document on the Internet. The HREF link is a portion of the document which, when selected by using an input device such as a mouse, activates a software connection module which allows a user to move between documents. Referring to FIG. 2, a login screen 20 for the virtual e-box is illustrated. If a user has previously created an account on the e-box system, the user may enter his or her P-Box name in input field 22 and the associated password input field 24. The user may then select HREF link 26 to Login and to view and/or modify the user's account information. A sample of the HTML code to generate screen 10 is included below.

TABLE 1
HTML Code for Screen 20

<HTML>
<HEAD>

<TITLE>Virtual E-Box Login</TITLE>

</HEAD>
<BODY LEFTMARGIN=0 TOPMARGIN=0 MARGINWIDTH=0
MARGINHEIGHT=0 BGCOLOR=“#FFFFFF”
onload=document.form1.pboxusername.focus()>
<TABLE BORDER=“0” CELLSPACING=“0” CELLPADDING=“0”
WIDTH=600>

<TR VALIGN=“TOP” ALIGN=“LEFT”>

<TD>

<TABLE BORDER=“0” CELLSPACING=“0”

CELLPADDING= “0” WIDTH=134>

<TR>

<TD ></TD>

</TR>

</TABLE>

</TD>
<TD>
<TABLE BORDER=“0” CELLSPACING=“0”

CELLPADDING=“0”>

<TR></TR>
<TR>

<TD ALIGN=“LEFT” BGCOLOR=“#FFFFFF”

CLASS=“plainlg”>

<br>

<TABLE border=“0” width=“469”>

<tr>

<td><FONT SIZE=“5”> Welcome to Virtual P.O. Box!<br>

<FONT SIZE=“4”> Please login below:

</td>
<td align=“right”>

<a href=javascript:need_account_click() class=“bluelink”

align=“right”>

Need an account?</a>

</td>

</tr>

</TABLE>
<p>
<form action=“./validate.asp” method=“post” id=“form1”
name=“form1” onSubmit=“return
login_click()”>

<input type=“hidden” name=“TargetURL”

value=“https://www.virtualebox.com/userlogin/form2.htm”>

<TABLE border=“0” width=“600”>

<tr>

<td width=“40”></td>
<td>

<TABLE>

<tr><td> P-Box User Name: </td></tr>
<tr><td>

<input maxlength=20 id=“pboxusername”

name=“pboxusername” onFocus=this.select ()>

</td></tr>

<tr><td> P-Box Password: </td></tr>
<tr><td>

<input maxlength=20 type=“pboxpassword”

id=“pboxpassword” name=“pboxpassword”
onFocus=this.select ()><br>

<td align=“right”>
<td><a href=javascript:forgot_click()

class=“bluelink” align=“right”>

<FONT FACE=“ARIAL, HELVETICA” SIZE=“1”>

Forgot your password? </a></td></td><br>

</td></tr>

<tr><td></td></tr>
<tr><td></td></tr>
<tr><td></td<>/tr>
<tr><td></td<>/tr>
<tr><td>

<a href=javascript:login_click()

class=“bluelink” border=“0”>

<FONT SIZE=“4”>LOGIN </a><br>

</td></tr>

</TABLE>

</td>
</td>

</td>
</TABLE>

</form>
<SCRIPT LANGUAGE=javascript>
// Username and password are required
function login_click() {

if (document.form1.pboxusername.value ==“ ”)
{

alert(“Please enter your P-Box user name.”);
document.form1.pboxusername.focus();
return false;

}
else if ((document.form1.pboxusername.value != “ ”) &&

(document.form1.pboxpassword.value ==
“ ”))

{

alert(“Please enter your P-Box password.”);
document.form1.pboxpassword.focus();
return false;

}
return true;

}
function processEnter(keypressed) {

var key;
if (document.all) {

key = window.event.keyCode;

}
else {

key = keypressed.which;

}
if (key == 13)
{

if (login_onclick()) {
document.form1.submit();

}
}

}
function forgot_click() {

document.form1.action = “./forgot.asp”;
document.form1.method = “post”;
document.form2.submit();

}
function need_account_click() {

document.form1.action = “./acctsetup.asp”;
document.form1.method = “post”;
document.form1.submit();

}
if (navigator.userAgent.indexOf(“MSIE 5”) == −1) {

document.form1.pboxpassword.onkeypress=processEnter;
document.form1.pboxusername.onkeypress=processEnter;

}
</SCRIPT>

</TD>

</TR>
<TR>
</TR>
<TR>
</TR>

</TABLE>

<TABLE BORDER=“0” CELLSPACING=“0”
<TR>

CELLPADDING=“0”>

<TR></TR><TR></TR><TR></TR><TR></TR>
<TD><font size=“2”> Copyright &copy; 2000 Virtual E-Box

Corporation |

<A HREF=“http://www.virtualebox.com/privacy.htm”

CLASS=“plainsmlink”>Privacy Policy</A></TD>

</TR>

</TABLE>

</TD>
</TR>

</TABLE>
</BODY>
</HTML>

If the user does not have an account and wishes to create one, the user may select HREF link 28 which then displays registration screen 30 as illustrated in FIG. 3. Registration screen 30 is divided into five sections, namely, personal information 32, P-Box name 34, P-Box address 36, P-Box password 38, and credit card information 40. Personal information section 32 may include input fields for e-mail address 42, first name 44, last name 46, street address 48, city 50, a select field for state 52, zip code input field 54 and telephone number 56. The personal information section 32 contains the user's actual name and shipping address, phone number and e-mail address which will be used to send products and/or information ordered or requested by the user to the user through the virtual e-box system 18.

P-Box section name 34 allows a user to create a new P-Box first name 58, last name 60 and P-Box number or name 62. If the user wishes to use his or her real name, the user selects box 64, and the first name entered in box 64 is copied into box 58 and last name entered into box 46 is copied into box 60. In this way, the user will not have to remember a new first name and last name when ordering products over the Internet but only a P-Box number 62.

Similarly, P-Box address section 36 is used by the user to create a P-Box city 68, select a P-Box state 70, and a P-Box zip code 72. As with P-Box name section 34, the user may wish to use his or her actual or real city, state and zip code by selecting box 66. If box 66 is selected, city 50 is copied into P-Box city 68, state 52 is copies into P-Box state 70 and zip code 54 is copies into P-Box zip code 72. This feature is useful to minimize the different information a user will have to remember when ordering online. If a user has a common name such as John Smith, for example, and lives in a large city such as New York City, only a P-Box number 62 may be necessary to insure the user's online privacy.

P-Box password section 38 is used to enter a password 74, confirming the password by entering the same password in box 76, and entering a hint in box 78 to remind the user of the selected password. Hint 78 is displayed if the user selects the “Forgot your password?” HTML link 80 shown in FIG. 2. If after receiving the hint 78, the user still cannot remember his or her password 74, the password may be e-mailed to the user's e-mail address 42.

Credit card information section 40 is used by the user to select a credit card from selection box 82 enter his or her credit card number 84 along with the expiration month 86 and year 88. As explained in more detail below, the user's credit card may be charged for handling fees, shipping costs, and indirectly for ordering products online. When the user has completed form 30, the user may select the “submit” the HTML link 92 to submit all the entered information to be verified and recorded. Various verification steps may be taken such as insuring that there are no duplicate e-mail addresses on file, no duplicate P-Box numbers or P-Box names, to name a few. Additionally, the credit card number will be verified to ensure that the number is valid and matches the name provided in the personal information section 32. A sample of the HTML code to generate screen 30 is included below.

TABLE 2
HTML Code for Screen 30

<HTML>
<HEAD>

<TITLE>Virtual E-Box Registration</TITLE>

</HEAD>
<BODY LEFTMARGIN=0 TOPMARGIN=0 MARGINWIDTH=0
MARGINHEIGHT=0 BGCOLOR=“#FFFFFF”>
<TABLE BORDER=“0” CELLSPACING=“0” CELLPADDING=“0”
WIDTH=750>

<TR VALIGN=“TOP” ALIGN=“LEFT”>

<TD>

<TABLE BORDER=“0” CELLSPACING=“0”

CELLPADDING=“0” WIDTH=150>

<TR>

<TD></TD>

</TR>

</TABLE>

</TD>
<TD>
<TABLE BORDER=“0” CELLSPACING=“0”

CELLPADDING=“0”>

<TR>
</TR>
<TR>

<TD ALIGN=“LEFT” BGCOLOR=“#FFFFFF”

CLASS=“plainlg”>
<br><font class=“plain”>
The information on this page is required to obtain a Virtual
E-Box.
<p>Please read our <a href=javascript:open_privacy()> Privacy
Policy </a></font> before applying.<p>
<form action=“./mts_acctsetup.asp” method=“post” name=“form1”>

<table border=“0” width=“350” class=“plain”>

<tr bgcolor=“#cccccc”>

<td colspan=3 class=“plainlgbold”>Personal

Information</td>

</tr>
<tr>

<td>E-Mail Address</td>

</tr>
<tr>

<td><input type=text name=strMyEmail maxlength=50

onFocus=this.select() value=“ ”></td>

</tr>
<tr>

<td>First Name</td>
<td>Last Name</td>

<.tr>
<tr>

<td><input type=text name=strMyFirstName width=30

maxlength=30 onFocus=this.select()
value=“ ”></td>

<td><input type=text name=strMyLastName maxlength=50

onFocus=this select()
value=“ ”></td>

</tr>
<tr>

<td>Street Address</td>

</tr>
<tr>

<td><input type=text name=strMyAddress maxlength=50

onFocus=this.select()
onChange=‘new_values()’ value=“ ”></td>

</tr>
<tr>

<td>City </td>
<td>State</td>
<td>Zip </td>

</tr>
<tr>

<td><input type=text name=strMyCity

onChange=‘new_values()’ onFocus=this.select()
maxlength=50 value=“ ”></td>

<td>

<select name=“strMyState” onChange=‘new_values()’>

| <option | SELECTED VALUE=“ ”>--Select a State-- |
|---|---|
| <option | VALUE=“AL”>Alabama |
| <option | VALUE=“AK”>Alaska |
| <option | VALUE=“AZ”>Arizona |
| <option | VALUE=“AR”>Arkansas |
| <option | VALUE=“CA”>California |
| <option | VALUE=“CO”>Colorado |
| <option | VALUE=“CT”>Connecticut |
| <option | VALUE=“DE”>Delaware |
| <option | VALUE=“DC”>D.C. |
| <option | VALUE=“FL”>Florida |
| <option | VALUE=“GA”>Georgia |
| <option | VALUE=“HI”>Hawaii |
| <option | VALUE=“ID”>Idaho |
| <option | VALUE=“IL”>Illinois |
| <option | VALUE=“IN”>Indiana |
| <option | VALUE=“IA”>Iowa |
| <option | VALUE=“KS”>Kansas |
| <option | VALUE=“KY”>Kentucky |
| <option | VALUE=“LA”>Louisiana |
| <option | VALUE=“ME”>Maine |
| <option | VALUE=“MD”>Maryland |
| <option | VALUE=“MH”>Marshall Islands |
| <option | VALUE=“MA”>Massachusetts |
| <option | VALUE=“MI”>Michigan |
| <option | VALUE=“MN”>Minnesota |
| <option | VALUE=“MS”>Mississippi |
| <option | VALUE=“MO”>Missouri |
| <option | VALUE=“MT”>Montana |
| <option | VALUE=“NE”>Nebraska |
| <option | VALUE=“NV”>Nevad.a |
| <option | VALUE=“NH”>New Hampshire |
| <option | VALUE=“NJ”>New Jersey |
| <option | VALUE=“NM”>New Mexico |
| <option | VALUE=“NY”>New York |
| <option | VALUE=“NC”>North Carolina |
| <option | VALUE=“ND”>North Dakota |
| <option | VALUE=“OH”>Ohio |
| <option | VALUE=“OK”>Oklahoma |
| <option | VALUE=“OR”>Oregon |
| <option | VALUE=“PA”>Pennsylvania |
| <option | VALUE=“RI”>Rhode Island |
| <option | VALUE=“SC”>South Carolina |
| <option | VALUE=“SD”>South Dakota |
| <option | VALUE=“TN”>Tennessee |
| <option | VALUE=“TX”>Texas |
| <option | VALUE=“UT”>Utah |
| <option | VALUE=“VA”>Virginia |
| <option | VALUE=“VT”>Vermont |
| <option | VALUE=“WA”>Washington |
| <option | VALUE=“WV”>West Virginia |
| <option | VALUE=“WI”>Wisconsin |
| <option | VALUE=“WY”>Wyoming</select> |
| | <td><input type=text name=strMyZip |

onChange=‘new_values ()’ onFocus=this.select()
maxlength=20 value=“ ”></td>

</tr
<tr>

<td>Phone</td>

</tr>
<tr>

<td><input type=text name=strMyPhone maxlength=20

onFocus=this.select()
value=“ ”></td>

</tr>

</table>

<p>

<table border=0 width=350 class=plain cellspacing=0>

<tr bgcolor=#cccccc>

<td class=plainlgbold>P-Box Name</td>
<td colspan=3 class=plainsm><input type=checkbox

name=SameName
onClick=‘samename_click()’checked>

Use my real name as my P-Box user name.

</td>

</tr>
<tr>

<td>P-Box First Name</td><td>P-Box Last Name</td><td>P-

Box Number (Name) </td>

</tr>
<tr>

<td><input type=text name=strPBoxFirstName

onFocus=this.select() maxlength=50 value=“ ”></td>
<td><input type=text name=strPBoxLastName
onFocus=this.select() maxlength=50 value=“ ”></td>

<td><input type=text name=strPBoxNumber maxlength=50

onFocus=this.select() value=“ ”></td>

</tr>

</table>

<p>

<table border=0 width=350 class=plain cellspacing=0>

<tr bgcolor=#cccccc>

<td class=plainlgbold>P-Box Address</td>
<td colspan=3 class=plainsm><input type=checkbox

name=SameAddr
onClick=‘sameaddr_click()’checked>

Use my real city/state/zip.

</td>

</tr>
<tr>

<td>P-Box City</td><td>P-Box State</td><td>P-Box

Zip</td>

</tr>
<tr>

<td><input type=text name=strMyCity

onChange=‘new_values()’ onFocus=this.select() maxlength=50
value=“ ”></td>
<td><select name=“strPBoxState”>

| | |
|---|---|
| <option | SELECTED VALUE=“ ”>--Select a State-- |
| <option | VALUE=“AL”>Alabama |
| <option | VALUE=“AK”>Alaska |
| <option | VALUE=“AZ”>Arizona |
| <option | VALUE=“AR”>Arkansas |
| <option | VALUE=“CA”>California |
| <option | VALUE=“CO”>Colorado |
| <option | VALUE=“CT”>Connecticut |
| <option | VALUE=“DE”>Delaware |
| <option | VALUE=“DC”>D.C. |
| <option | VALUE=“FL”>Florida |
| <option | VALUE=“GA”>Georgia |
| <option | VALUE=“HI”>Hawaii |
| <option | VALUE=“ID”>Idaho |
| <option | VALUE=“IL”>Illinois |
| <option | VALUE=“IN”>Indiana |
| <option | VALUE=“IA”>Iowa |
| <option | VALUE=“KS”>Kansas |
| <option | VALUE=“KY”>Kentucky |
| <option | VALUE=“LA”>Louisiana |
| <option | VALUE=“ME”>Maine |
| <option | VALUE=“MD”>Maryland |
| <option | VALUE=“MA”>Massachusetts |
| <option | VALUE=“MI”>Michigan |
| <option | VALUE=“MN”>Minnesota |
| <option | VALUE=“MS”>Mississippi |
| <option | VALUE=“MO”>Missouri |
| <option | VALUE=“MT”>Montana |
| <option | VALUE=“NE”>Nebraska |
| <option | VALUE=“NV”>Nevada |
| <option | VALUE=“NH”>New Hampshire |
| <option | VALUE=“NJ”>New Jersey |
| <option | VALUE=“NM”>New Mexico |
| <option | VALUE=“NY”>New York |
| <option | VALUE=“NC”>North Carolina |
| <option | VALUE=“ND”>North Dakaota |
| <option | VALUE=“OH”>Ohio |
| <option | VALUE=“OK”>Oklahoma |
| <option | VALUE=“OR”>Oregon |
| <option | VALUE=“PA”>Pennsylvania |
| <option | VALUE=“RI”>Rhode Island |
| <option | VALUE=“SC”>South Carolina |
| <option | VALUE=“SD”>South Dakota |
| <option | VALUE=“TN”>Tennessee |
| <option | VALUE=“TX”>Texas |
| <option | VALUE=“UT”>Utah |
| <option | VALUE=“VA”>Virginia |
| <option | VALUE=“VT”>Vermont |
| <option | VALUE=“WA”>Washington |
| <option | VALUE=“WV”>West Virginia |
| <option | VALUE=“WI”>Wisconsin |
| <option | VALUE=“WY”>Wyoming</select> |

</td>

<td><input type=text name=strPBoxZip maxlength=20

onFocus=this.select() value=“ ”<>/td>

</tr>
<tr>

<td colspan=3>
<font class=plainsm>*The P-Box address is the address

appearing on your mail. </font><br>

</td>

</tr>

</table>

<p>

<table border=0 width=350 class=plain cellspacing=0>

<tr bgcolor=#cccccc>

<td colspan=3 class=plainlgbold>P-Box Password</td>

</tr>
<tr>

<td>Password</td><td>Confirm Password</td><td>Hint</td>

</tr>
<tr>

<td><input type=text name=strPBoxPassword

onFocus=this.select() maxlength=50 value=“ ”></td>

<td><input type=text name=strPBoxConfirmPassword

maxlength=50 onFocus=this.select() value=“ ”></td>
<td><input type=text name=strPBoxPasswordHint maxlength=50
onFocus=this.select() value=“ ”></td>

</tr>
</table>

<p>

<table border=0 width=350 class=plain cellspacing=0>

<tr bgcolor=#cccccc>

<td colspan=3 class=plainlgbold>Credit Card

Information</td>

</tr>
<tr>

<td>Credit Card</td>
<td>Credit Card Number</td>

</tr>
<tr>

<td>
<select name=“strCreditCard” onChange=‘new_values()’>
<option SELECTED VALUE=“ ”>Select Credit Card
<option VALUE=“Visa”>Visa
<option VALUE=“Mastercard”>Mastercard
<option VALUE=“Discover”>Discover
<option VALUE=“American Express”>American Express</select>
</td>
<td><input type=text name=strCreditCard
onChange=‘new_values()’ onFocus=this.select() maxlength=50
value=“ ”></td>

<tr>

<td>Expiration Month</td>

<td>Expiration Year</td>
</tr>
<tr>

<td>

| | |
|---|---|
| <select | name=“strExpireMonth”> |
| <option | SELECTED VALUE=“ ”>Select Month |
| <option | VALUE=“01”>January |
| <option | VALUE=“02”>February |
| <option | VALUE=“03”>March |
| <option | VALUE=“04”>April |
| <option | VALUE=“05”>May |
| <option | VALUE=“06”>June |
| <option | VALUE=“07”>July |
| <option | VALUE=“08”>August |
| <option | VALUE=“09”>September |
| <option | VALUE=“10”>October |
| <option | VALUE=“11”>November |
| <option | VALUE=“12”>December |

</select>
</td>
<td>

| | |
|---|---|
| <select | name=“strExpireYear”> |
| <option | SELECTED VALUE=“ ”>Select Year |
| <option | VALUE=“2000”>2000 |
| <option | VALUE=“2001”>2001 |
| <option | VALUE=“2002”>2002 |
| <option | VALUE=“2003”>2003 |
| <option | VALUE=“2004”>2004 |
| <option | VALUE=“2005”>2005 |
| <option | VALUE=“2006”>2006 |
| <option | VALUE=“2007”>2007 |
| <option | VALUE=“2008”>2008 |
| <option | VALUE=“2009”>2009 |
| <option | VALUE=“2010”>2010</select> |

</tr>

</table>

<tr><td><br></td></tr>
<tr>

<td><a href=javascript:history.back() class=“bluelink”

border=0><font size=“4”> BACK </a></td>

<td colspan=2 align=right><a

href=“http://www.virtualebox.com/form2” class=“bluelink”
border=0>

<font size=“4~>SUBMIT\/NEXT </a></td>

</tr>

</table>

<input type=hidden name=NextPage value=“2”>
<input type=hidden name=TargetURL
value=“https://www.virtualebox.com//login.htm”>
<input type=hidden name=strBEmail value=“ ”>
<input type=hidden name=strBFirstName value=“ ”>
<input type=hidden name=strBLastName value=“ ”>
<input type=hidden name=strBAddress value=“ ”>
<input type=hidden name=strBCity value=“ ”.
<input type=hidden name=strBState value=“ ”>
<input type=hidden name=strBZip value=“ ”>
<input type=hidden name=strBPhone value=“ ”>
<input type=hidden name=strSEmail value=“ ”>
<input type=hidden name=strSFirstName value=“ ”>
<input type=hidden name=strSLastName value=“ ”>
<input type=hidden name=strSAddress value=“ ”>
<input type=hidden name=strSCity value=“ ”>
<input type=hidden name=strSState value=“ ”>
<input type=hidden name=strSZip value=“ ”>
<input type=hidden name=strSPhone value=“ ”>
</form>
<script language=javascript>
function open_privacy() {

window.open(‘./privacy.htm’, ‘privacy’,

‘directories=0, personalbar=0, toolbar=0, scrollbars=1, height=400,
width=800’);
}
function samename_click() {

if (document.form1.SameName.checked == true) {

document.form1.strPBoxFirstName.value =

document.form1.strMyFirstName.value;

document.form1.strPBoxLastName.value

document.form1.strMyLastName.value;

} else {

document.form1.strPBoxFirstName.value = ‘ ’;
document.form1.strPBoxLastName.value = ‘ ’;

}
return true;

}
function sameaddr_click() {

if (document.form1.SameAddr.checked == true) {

document.form1.strPBoxAddress.value =

document.form1.strMyAddress.value;

document.form1.strPBoxCity.value =

document.form1.strMyCity.value;

document.form1.strPBoxState.value =

document.form1.strMyState.value;

document.form1.strPBoxZip.value =

document.form1.strMyZip.value;

} else {

document.form1.strPBoxAddress.value = ‘ ’;
document.form1.strPBoxCity.value = ‘ ’;
document.form1.strPBoxState.value = ‘ ’;
document.form1.strPBoxZip.value = ‘ ’;

}
return true;

}
function new_values() {

if (document.form1.SameName.checked == true) {

document.form1.strPBoxAddress.value =

document.form1.strMyAddress.value;

document.form1.strPBoxCity.value =

document.form1.strMyCity.value;

document.form1.strPBoxState.value =

document form1.strMyState.value;

document.form1.strPBoxZip.value =

document.form1.strMyZip.value;

}
return true;

}
</script>
</td>
</TABLE>
</tr>
<!TABLE BORDER=“0” CELLSPACING=“0” CELLPADDING=“0”>
<table border=“0” width=“750” class=“plain”>

<TD COLSPAN=“2” VALIGN=“MIDDLE” ALIGN =“CENTER”

BGCOLOR=“#FFFFFF” CLASS=“plainsm”>

<p><font size=“2”>Copyright &copy; 2000 Virtual E-Box

Corporation

|
<A HREF=“http://www.virtualebox.com/privacy.htm”

CLASS=“plainsmlink”>Privacy Policy</A></TD>

</TR>

</TABLE

</TR>

</TABLE>
</BODY>
</HTML>

After selecting “submit” link 92 and all the entered information from page 30 is verified, a confirmation page (not shown) may be displayed for the user to verify the data entered on page 30. When this information is finally accepted and submitted by the user, an information page 120 (FIG. 4) may be displayed which includes the user's P-Box name, P-Box number, P-Box e-mail account name, and verified credit card number as further discussed below.

If the user wishes to change or update his or her account, the user may select HTML link 122 to return to page 30 (FIG. 3). When going from page 120 to page 30, all data fields are filled in automatically for the user to edit and then resubmit the changes.

From page 120 the user may also wish to receive mailing labels and purchase prepaid postage 124. The labels may include a bar code to enable the post office or shipper to process the package automatically and debit the user's account as further described herein below. The user may pay by selecting to have his or her credit card charged each time a label is used by selecting box 126, or the user may pay by selecting box 128 to debit his or her credit card the amount entered in box 130. Selecting the NEXT link 132, a confirmation screen is displayed showing the user's account status (not shown).

Referring to FIG. 1, a user at a physical location 14 may use personal computer 12 to access the virtual e-box system 18 through ISP 16 over phone lines 96 or other connection means to the Internet 97. Virtual e-box web pages 98 are displayed on personal computer 12. Web pages 98 consist of log in screen 30, registration screen 30 and other information screens. After the user has created an account as described above for FIG. 3, this information is stored in one or more databases 100 on web site server 94. Once the user's account is set up, the user is free to order merchandise or other information over the Internet using his or her e-box. For example, using personal computer 12 connected to the Internet 97, the user may access web site 102 which displays graphics and information regarding electronic products 104 such as CD players, for example. If the user wishes to purchase one of these products, the user will fill out a form on web site 102 by entering name, address, phone number, and credit card information on web page 106. Instead of using his or her real name and physical address, the user may use his or her virtual e-box name and address. Web site 102 notifies warehouse 108 of the user's order and sends warehouse 108 the user's information from page 106. Warehouse 108 packages the merchandise and labels the package for shipping.

In one embodiment, the product may be shipped via the U.S. postal service or a commercial shipper, such as United Parcel Service (UPS) or Federal Express (FedEx) 110, to a virtual e-box re-mailer location 112 as indicated on the mailing label in this embodiment, the P-Box address 36 would be assigned to the user by the virtual e-box system to be the physical address of the e-box re-mailer location 112. The package is then automatically scanned and the user's physical mailing address is retrieved from database 100 and a new label printed using the user's real name and address and applied to the package. The re-labeled package is then shipped using shipper 110 delivered to the user at location 14. Alternatively, shipper 110 may access database 100 directly using a secure line 116 or other secure means over the Internet to match the P-Box name and number to the actual user and address. Shipper 110 may then directly re-label the package and deliver it to the user. Shipper 110 may charge the user a re-labeling fee using the user's credit card number. The web page accessed by shipper 110 (not shown) includes only the data the user wishes to be viewed. For example, the user may only want the shipper to know his or her physical address, but not his or her real name.

In another embodiment, the virtual e-box system may assign the user a virtual credit card number that is owned by the virtual e-box system. The virtual credit card number may then be used by the user to purchase goods over the Internet or other network anonymously. In this way, no identifying information is provided on the Internet to an online merchant by the user. The only location where the e-box information is linked to the actual user is controlled by the virtual e-box system 18 which may only be viewed by the user and authorized shippers 110 or law enforcement personnel.

E-box users wishing to use prepaid services may request mailing labels from the virtual e-box system which can be used as stamps. The mailing labels may include the user's P-Box name, P-Box address, and P-Box number along with a bar code, machine readable indicia for automatic processing. In the preferred embodiment, the bar code includes such information as the web site address and P-Box number and an authentication number. Upon receiving the letter/package, the Post Office shipper 110 may scan the bar code to charge the e-box owner the necessary amount of postage. Alternatively, the shipper may enter the P-Box name along with an authorization password provided to the shipper over the Internet link to charge the P-Box owner for shipping.

It is to be understood that while certain forms of this invention have been illustrated and described, it is not limited thereto, except in so far as such limitations are included in the following claims.

Having thus described the invention, what is claimed as new and desired to be secured by letters patent is as follows:

1. A method of receiving an item in an online environment from an online item provider without disclosing the real name and real address of the user to said online item provider, comprising:
connecting a computer to an Internet service provider,
running a browser on said computer,
accessing a first Web site using said browser,
storing the user's real name and real address on said Web site,
storing a virtual name and virtual address on said Web site linked to said real name and real address,
accessing a second Web site of said online item provider presenting said item to said user,
selecting said item to be received by said user from said online item provider, and
utilizing said virtual name and virtual address on said second Web site for shipping information by said online item provider.

2. The method as claimed in claim 1 further comprising the steps of:
shipping said item to said virtual name at said virtual address,
receiving said item at a location corresponding to said virtual address,
relabeling said item with said user's real name and real address by accessing said stored information on said first Web site, and
shipping said item to said real name at said real address.

3. The method as claimed in claim 1 further comprising the steps of:
providing said item to a shipper having access to a third Web site associated with said first web site,
connecting to said third Web site and associating said virtual address with said real address, and
delivering said item to said real address.

4. The method as claimed in claim 1 further comprising the steps of:
selecting and storing an optional payment method presented by said first Web site, and
linking said virtual name and said virtual address to said payment method.

5. The method as claimed in claim 4 further comprising the steps of:
providing said payment method to said online item provider, and
utilizing said payment method to receive a payment for said item selected.

6. The method as claimed in claim 5 further comprising the steps of:
shipping said item to said virtual name at said virtual address,
receiving said item at a secure location corresponding to said virtual address,
relabeling said item with said user's real name and real address by accessing said stored information on said first Web site,
utilizing said payment method linked to said virtual name and virtual address to receive a shipping and handling payment, and
shipping said item to said real name at said real address.

7. The method as claimed in claim 5 further comprising the steps of:
providing said item to a shipper having access to a third Web site associated with said first Web site,
connecting to said third Web site and associating said virtual address with said real address,
utilizing said payment method linked to said virtual name and virtual address to receive a shipping and handling payment, and
delivering said item to said real address.

8. The method as claimed in claim 1 further comprising the steps of:
entering and storing a real credit card number associated with said real name and real address on said Web site, and
providing said user with a virtual credit card number associated with said virtual name and virtual address.

9. The method as claimed in claim 8 further comprising the steps of:
providing said virtual credit card number to said online item provider, and
utilizing said virtual credit card number to receive a payment for said item selected.

10. The method as claimed in claim 9 further comprising the steps of:
shipping said item to said virtual name at said virtual address,
receiving said item at a location corresponding to said virtual address,
relabeling said item with said user's real name and real address by accessing said stored information on said first Web site,
utilizing said real credit card linked to said virtual name and virtual address to receive a shipping and handling payment, and
shipping said item to said real name at said real address.

11. The method as claimed in claim 9 further comprising the steps of:
providing said item to a shipper having access to a third Web site associated with said first web site,
connecting to said third Web site and associating said virtual address with said real address,
utilizing said virtual credit card associated with said virtual name and virtual address to receive a shipping and handling payment, and
delivering said item to said real address.

12. A method of providing, receiving and using prepaid mailing labels in an online environment utilizing a virtual name and virtual address for providing payment, comprising:
displaying a web page on a user computer connected to an internet service provider and running a browser, said web page from a server hosting a first web page for establishing a virtual name and virtual address and providing payment information;
entering and storing a real name, a real address and payment information on said Web site for said user;
entering and storing a virtual name and virtual address on said Web site linked to said payment information, and
providing prepaid shipping labels to said user preprinted with said virtual name, virtual address, and an indicia encoding said virtual name, said virtual address, and a payment web site address having a link to said first web site for accessing said payment information.

13. The method as claimed in claim 12, further comprising the steps of:
applying said shipping labels to a package having a mailing address and mailing said package,
scanning said barcode,
linking to said payment web site and posting a charge based on said payment information associated with said virtual name and virtual address, and
shipping said package to address on said package.

14. A method of receiving goods in an online environment utilizing a virtual name and address, comprising:
connecting a computer to an Internet service provider,
running a browser on said computer,
accessing a first Web site for establishing a virtual name and virtual address using said browser,
storing the user's real name and real address on said Web site,
storing a virtual name and virtual address on said Web site linked to said real name and real address,
accessing a second Web site presenting goods of interest to said user,
selecting at least one of said goods to be received by said user,
providing said virtual name and virtual address to said second Web site for shipping information,
labeling said goods with said virtual name and said virtual address,
providing said goods to a shipper having access to a third Web site associated with said first Web site,
connecting to said third Web site and associating said virtual address with said real address, and
delivering said goods to said real address.

15. The method as claimed in claim 14 further comprising the steps of:
providing prepaid shipping labels to said user preprinted with said virtual name, virtual address, and an indicia encoding said virtual name, said virtual address, and a payment Web site address having a link to said first Web site for accessing said payment information.

16. The method as claimed in claim 15 further comprising the steps of:
applying said shipping labels to a package having a mailing address and mailing said package,
scanning said indicia,
linking to said payment Web site and posting a charge based on said payment information associated with said virtual name and virtual address, and
shipping said package to address on said package.

17. The method as claimed in claim 16 wherein said indicia is a barcode.
